(19) United States
(12) Patent Application Publication
(10) Pub. No.: US 2026/0208655 A1
(43) Pub. Date: Jul. 23, 2026

(54) REEL TRAILER

(71) Applicant: Michael W. SCOTT, Hagerstown, MD (US)

(72) Inventor: Michael W. SCOTT, Hagerstown, MD (US)

(21) Appl. No.: 19/450,139

(22) Filed: Jan. 15, 2026

Related U.S. Application Data
(60) Provisional application No. 63/746,611, filed on Jan. 17, 2025.

(51) Int. Cl. B60P 3/035

(52) U.S. Cl. CPC B60P 3/035

(57) ABSTRACT

The present disclosure provides a reel trailer configured to be hitched to and towed behind a motorized vehicle. The reel trailer includes a frame upon which a cable reel is loaded, a hydraulic crane mounted on the reel trailer, a telescopic mast pole light mounted on the reel trailer, and a rear gate. The reel trailer is configured to adjust in size to accommodate different-sized cable reels. The reel trailer includes jack outriggers configured to deploy and hydraulically lift the reel trailer such that one side is elevated to allow the reel trailer to expand in width. The reel trailer further includes a winch mounted on the rear gate, configured to unwind cable from the cable reel and distribute the cable.

### CROSS-REFERENCE TO RELATED APPLICATIONS

This application claims priority to U.S. Provisional Application No. 63/746,611, titled Reel Trailer, filed Jan. 17, 2025, which is hereby incorporated by reference in its entirety.

### TECHNOLOGY FIELD

The present disclosure relates to a utility trailer for transporting and handling cable reels, and more particularly to an expandable reel trailer configured to load, transport, and facilitate cable installation and removal operations.

### BACKGROUND

The transportation and installation of electrical cables, particularly high-voltage cables, present significant logistical challenges in the power transmission and distribution industry. These cables are typically manufactured and wound onto large reels or drums for transport to construction sites where they are installed underground. The size and weight of cable reels can be substantial, with some larger reels measuring up to 10 feet in width, 14 feet in diameter, and weighing as much as 100,000 pounds.

The logistics of moving such massive cable reels from manufacturing or storage facilities to installation sites requires specialized equipment and careful planning. Heavy-duty trucks are often employed for transport due to the considerable weight and dimensions of the reels. Upon arrival at a construction site, additional challenges arise in maneuvering the vehicle carrying the cable reel and finding adequate space for unloading and handling operations.

Cable installation projects frequently involve multiple stages and locations along the intended cable path. This includes areas for placing the cable reel, unwinding the cable, connecting cable sections, and in some cases, removing and replacing existing underground cables. The process of unwinding cable from a reel and guiding it into trenches or conduits demands precision and specialized equipment to prevent damage to the cable.

Furthermore, the replacement of older underground cables, such as oil-filled electricity cables that have been in use for decades, introduces additional complexities. These legacy cables can pose environmental risks if left in place after decommissioning, as the insulation oil they contain may eventually leak into surrounding soil and water systems due to natural ground movements, joint failures, or accidental damage during other construction activities.

The power transmission and distribution industry continually seeks ways to improve the efficiency and safety of cable transport and installation processes. Innovations in this field aim to address challenges such as reducing the number of vehicles and equipment required at construction sites, improving the maneuverability of cable-handling equipment, and enhancing the ability to work with various cable reel sizes and weights.

Advancements in trailer design and functionality could potentially streamline operations by integrating multiple cable handling capabilities into a single unit. Such potential improvements might include features for loading and unloading cable reels, facilitating cable unwinding during installation, and even assisting in the removal and rewinding of decommissioned cables onto empty reels for proper disposal.

As the demand for electrical power continues to grow, driven by factors such as urbanization, industrial development, and the integration of renewable energy sources, the need for efficient and versatile cable transportation and installation solutions remains an ongoing focus in the industry.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a reel trailer is provided. The reel trailer includes an expandable frame configured to support a cable reel, a lift assembly mounted on the frame and configured to engage an arbor of the cable reel, a hydraulic system configured to adjust a width of the frame, and a rear gate pivotally attached to the frame.

According to other aspects of the present disclosure, the reel trailer includes one or more of the following features. The reel trailer includes a hydraulic crane mounted on the frame and configured to lift and position the arbor. The reel trailer includes a telescopic mast pole light mounted on the frame and configured to provide illumination at a construction site. The reel trailer includes a winch mounted on the rear gate and configured to wind or unwind cable from the cable reel. The hydraulic system includes jack outriggers configured to deploy and lift one side of the frame, and hydraulic cylinders configured to expand and retract the frame. The reel trailer includes ground plates configured to provide a stable path for wheels of the jack outriggers during expansion of the frame. The reel trailer includes a rim drive arm mounted on the frame and configured to rotate the cable reel, the rim drive arm comprising a pair of drive wheels and a hydraulic cylinder configured to move the rim drive arm toward and away from the cable reel.

According to another aspect of the present disclosure, a method of operating a reel trailer is provided. The method includes expanding a width of a frame of the reel trailer using a hydraulic system, engaging an arbor of a cable reel with a lift assembly mounted on the frame, and securing the cable reel on the expanded frame.

According to other aspects of the present disclosure, the method includes one or more of the following features. The method includes deploying jack outriggers to lift one side of the frame and expanding the frame using hydraulic cylinders. The method includes placing ground plates to provide a stable path for wheels of the jack outriggers during expansion of the frame. The method includes using a hydraulic crane mounted on the frame to lift and position the arbor of the cable reel. The method includes rotating the cable reel using a rim drive arm mounted on the frame, the rim drive arm comprising a pair of drive wheels. The method includes adjusting a position of the rim drive arm relative to the cable reel using a hydraulic cylinder. The method includes winding or unwinding cable from the cable reel using a winch mounted on a rear gate of the frame.

According to another aspect of the present disclosure, a cable reel handling system is provided. The system includes a reel trailer having an expandable frame, a hydraulic crane mounted on the frame and configured to position an arbor for insertion into a cable reel, and a rim drive arm mounted on the frame and configured to rotate the cable reel.

According to other aspects of the present disclosure, the cable reel handling system includes one or more of the following features. The system includes a lift assembly mounted on the frame and configured to engage the arbor of the cable reel. The lift assembly includes an arbor slot configured to receive the arbor and a support ledge positioned below the arbor slot to provide support for the arbor when loaded. The lift assembly may further include a panel door configured to secure the arbor within the lift assembly when closed. The rim drive arm includes a pair of drive wheels configured to contact an outer surface of the cable reel and a hydraulic cylinder configured to move the rim drive arm toward and away from the cable reel. The system includes a control panel with levers configured to operate the hydraulic crane, the rim drive arm, and the lift assembly.

The foregoing general description of the illustrative embodiments and the following detailed description thereof are merely exemplary aspects of the teachings of this disclosure and are not restrictive.

### BRIEF DESCRIPTION OF DRAWINGS

Non-limiting and non-exhaustive examples are described with reference to the following figures. Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an isometric view of a reel trailer, according to aspects of the present disclosure.

FIG. 2 illustrates an orthogonal side view of a reel trailer during lift and width adjustment operations, according to an embodiment.

FIG. 3 illustrates an orthogonal view of a reel trailer in an expanded configuration, according to aspects of the present disclosure.

FIG. 4 illustrates an orthogonal view of a reel trailer with a cable reel positioned for loading, according to an embodiment.

FIG. 5 illustrates a side view of a portion of a reel trailer showing details of a lift assembly, according to aspects of the present disclosure.

FIG. 6 illustrates an isometric view of a reel trailer in a retracted state, according to an embodiment.

FIG. 7 illustrates a side view of a reel trailer, according to aspects of the present disclosure.

FIG. 8 illustrates a rear orthogonal view of the reel trailer in a retracted state, according to an embodiment.

FIG. 9 illustrates a top orthogonal view of the reel trailer in a retracted state, according to aspects of the present disclosure.

FIG. 10 illustrates an isometric view of the reel trailer in an expanded state, according to an embodiment.

FIG. 11 illustrates an isometric view of a reel trailer in an expanded configuration, according to aspects of the present disclosure.

FIG. 12 illustrates a rear view of a reel trailer in an expanded state, according to an embodiment.

FIG. 13 illustrates a perspective view of a reel trailer in an expanded configuration with a cable reel mounted, according to aspects of the present disclosure.

FIG. 14 illustrates a side orthogonal view of a reel trailer with a cable reel mounted, according to an embodiment.

FIG. 15 illustrates an isometric view of a reel trailer in an expanded configuration with a cable reel mounted, according to aspects of the present disclosure.

FIG. 16 illustrates an isometric view of a reel trailer with a cable reel mounted, according to an embodiment.

FIG. 17 illustrates an orthogonal side view showing the operational reach of a hydraulic crane, according to aspects of the present disclosure.

FIG. 18 illustrates a left frame assembly, according to aspects of the present disclosure.

FIG. 19 illustrates a right frame assembly, according to aspects of the present disclosure.

FIG. 20 illustrates a portion of the hitch weldment, according to aspects of the present disclosure.

FIG. 21 illustrates another portion of the hitch weldment, according to aspects of the present disclosure.

FIGS. 22A, 22B, and 22C illustrate different views of the lift assembly, according to aspects of the present disclosure.

FIG. 23 illustrates a rear gate, according to aspects of the present disclosure.

FIGS. 24A and 24B illustrate different views of the rim drive arm and drive wheels, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

It is to be understood that the following disclosure provides many different embodiments, or examples, for implementing different features of the present application. Specific embodiments or examples of components and arrangements are described below to simplify the present disclosure. These are, of course, merely examples and are not intended to be limiting. For example, dimensions of elements are not limited to the disclosed range or values but may depend upon process conditions and/or desired properties of the device. Moreover, the formation of a first feature over or on a second feature in the description that follows includes embodiments in which the first and second features are formed in direct contact, and may also include embodiments in which additional features may be formed by interposing the first and second features, such that the first and second features may not be in direct contact. Various features may be arbitrarily drawn in different scales for simplicity and clarity. In the accompanying drawings, some layers/features may be omitted for simplification.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the reel trailer in use or operation, in addition to the orientation depicted in the figures. The reel trailer may be otherwise oriented (rotated 90 degrees or at other orientations), and the spatially relative descriptors used herein may likewise be interpreted accordingly. In addition, the term “made of” may mean either “comprising” or “consisting of.” In the present disclosure, the phrase “at least one of A, B, and C” means either one of A, B, C, A+B, A+C, B+C, or A+B+C, and does not mean one from A, one from B, and one from C, unless otherwise explained.

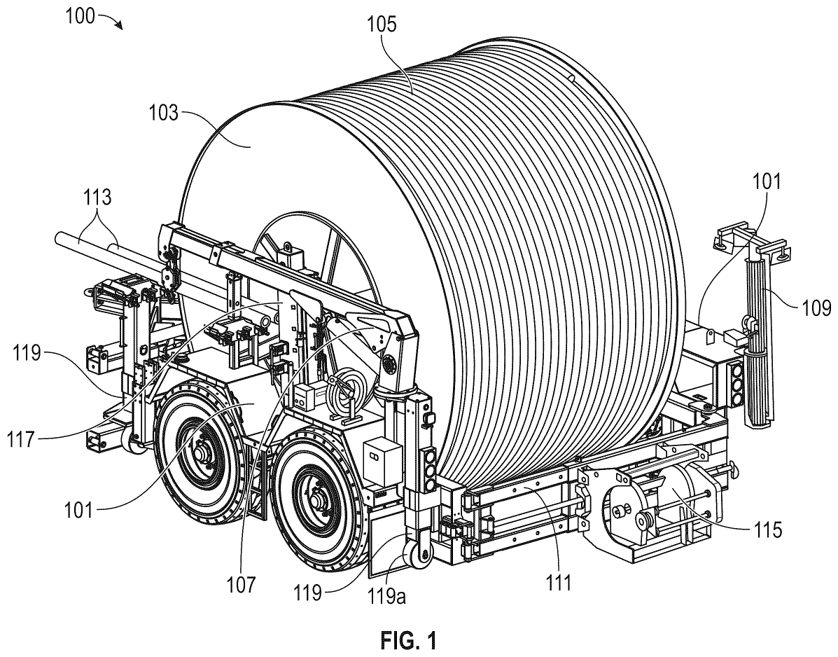

FIG. 1 illustrates an isometric view of a reel trailer 100. The reel trailer 100 includes a frame 101 configured to support a cable reel 103. In some cases, the cable reel 103 may have cable 105 wound around the cable reel 103. The reel trailer 100 may be designed to accommodate cable reels 103 of assorted sizes. In some implementations, the reel trailer 100 may support cable reels 103 with dimensions of approximately 10 feet in width and 14 feet in diameter. In other cases, the reel trailer 100 is configured to handle cable reels 103 with dimensions of approximately 7 feet in width and 10 feet in diameter, 8 feet in width and 11 feet in diameter, or 9 feet in width and 13 feet in diameter. In some embodiments, the reel trailer is configured to accommodate and transport a cable reel having a weight of about 50,000 pounds. In some embodiments, the reel trailer is configured to accommodate and transport a cable reel having a weight of about 70,000 pounds. In some embodiments, the reel trailer is configured to accommodate and transport a cable reel having a weight of about 100,000 pounds.

The reel trailer 100 includes a hydraulic crane 107 and a telescopic mast pole light 109 mounted on opposite sides of the reel trailer 100 near a rear gate 111, as shown in FIG. 1. The hydraulic crane 107 is configured to lift and position an arbor 113 for insertion into the cable reel 103. A winch 115 is mounted on the rear gate 111 and is configured to assist with winding or unwinding the cable 105 from the cable reel 103.

The reel trailer 100 includes a lift assembly 117 on each side, designed to engage with the arbor 113 when the cable reel 103 is loaded. Jack outriggers 119 is provided on one side of the reel trailer 100, with each jack outrigger 119 having an outrigger wheel 119a. In other embodiments, additional jack outriggers are provided. The jack outriggers 119 enable the reel trailer 100 to be partially elevated off the ground surface 125 for width adjustment to accommodate different-sized cable reels 103. In the embodiment of FIG. 1, the left frame assembly of the reel trailer 100 includes jack outrigger 119 at front and back ends of the reel trailer to allow the left frame assembly of the reel trailer to move outwardly away from the right frame assembly.

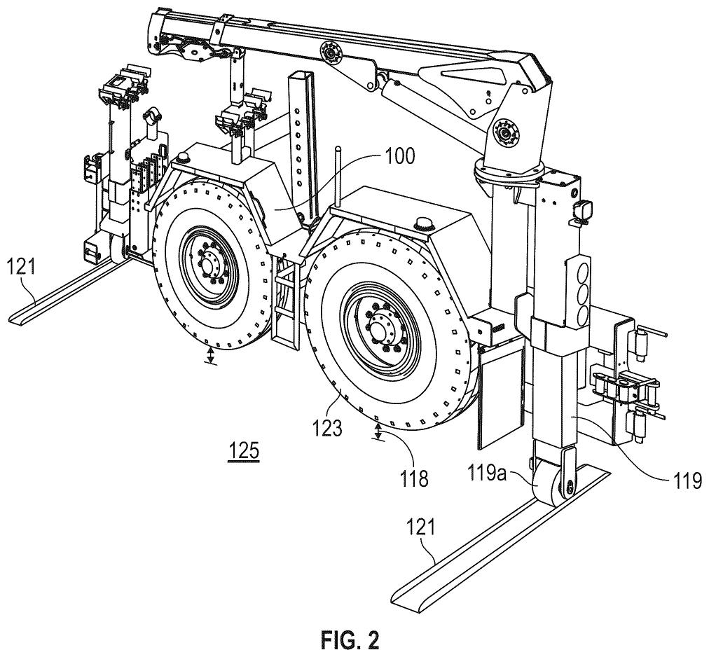

FIG. 2 illustrates an orthogonal side view of the reel trailer 100 during width adjustment operations. The reel trailer 100 includes a width adjustment mechanism to accommodate cable reels 103 of assorted sizes.

In some embodiments, the width adjustment mechanism includes the jack outriggers 119 positioned along one side of the reel trailer 100. Each jack outrigger 119 includes an outrigger wheel 119a that enables controlled movement during the width adjustment process. In some embodiments, the reel trailer 100 includes ground plates 121 positioned on a ground surface 125. The ground plates 121 provides a stable path for the outrigger wheels 119a to roll along during expansion of the reel trailer 100.

The reel trailer 100 includes trailer tires 123 on one side of the frame 101. During the width adjustment process, the jack outriggers 119 may be deployed to lift two of the trailer tires 123 on one side of the reel trailer above the ground surface 125 (FIG. 2). In some embodiments, this elevation allow the reel trailer 100 to expand horizontally. In other words, the one side of the frame assembly is moved outwardly away from the other frame side assembly. In some embodiments, the jack outriggers 119 provide the lifting force to elevate the trailer tires 123 to a predetermined height above the ground surface 125. In some embodiments, the predetermined height is about 10 to about 14 inches above the ground surface 125. In some embodiments, the predetermined height is about 12 inches above the ground surface 125.

In some implementations, the outrigger wheels 119a may roll along the ground plates 121, facilitating controlled lateral movement of one side of the frame assembly to effectively expand or widen the reel trailer 100. This configuration allows for controlled expansion of the reel trailer 100 while maintaining stability during the adjustment process.

In some embodiments, the ground plates 121 work in conjunction with the outrigger wheels 119a to provide a stable surface for the width adjustment operation while the trailer tires 123 on one side of the reel trailer remain elevated above the ground surface 125 (FIG. 2). This arrangement enables the reel trailer 100 to safely and efficiently adjust its width to accommodate different-sized cable reels 103. In some embodiments, the ground plates are stored on the reel trailer when not in use.

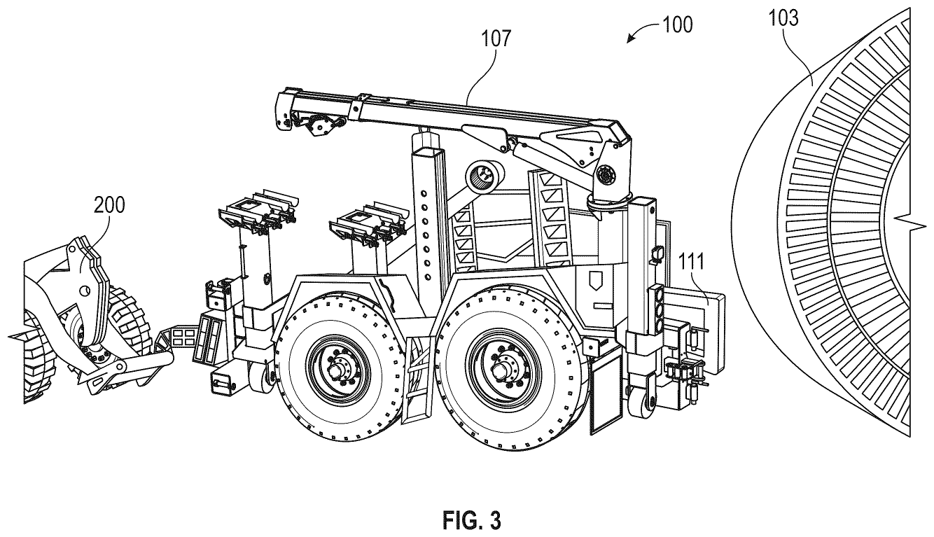

FIG. 3 illustrates an orthogonal view of the reel trailer 100 in an expanded configuration. In the example of FIG. 3, the reel trailer 100 is hitched to a motorized vehicle 200 and positioned near the cable reel 103. The rear gate 111 of the reel trailer 100 is in an opened position to allow the reel trailer 100 to be backed up by the motorized vehicle 200 toward the cable reel 103. In this embodiment, the width of the reel trailer 100 has been adjusted based on the size of the cable reel 103 that is to be received and loaded. The reel trailer 100 is configured such that the cable reel 103 can be received between the side frame assemblies of the reel trailer 100 when the motorized vehicle 200 moves the reel trailer 100 into position.

In some cases, the motorized vehicle 200 may be a tractor, wheel loader, or motorized power unit. The motorized vehicle 200 may have enhanced steering capabilities to facilitate precise positioning of the reel trailer 100 relative to the cable reel 103. In some embodiments, the motorized vehicle is operated by remote control by an operator positioned around the reel trailer to make necessary adjustments to ensure the reel trailer is aligned to received the cable reel 103.

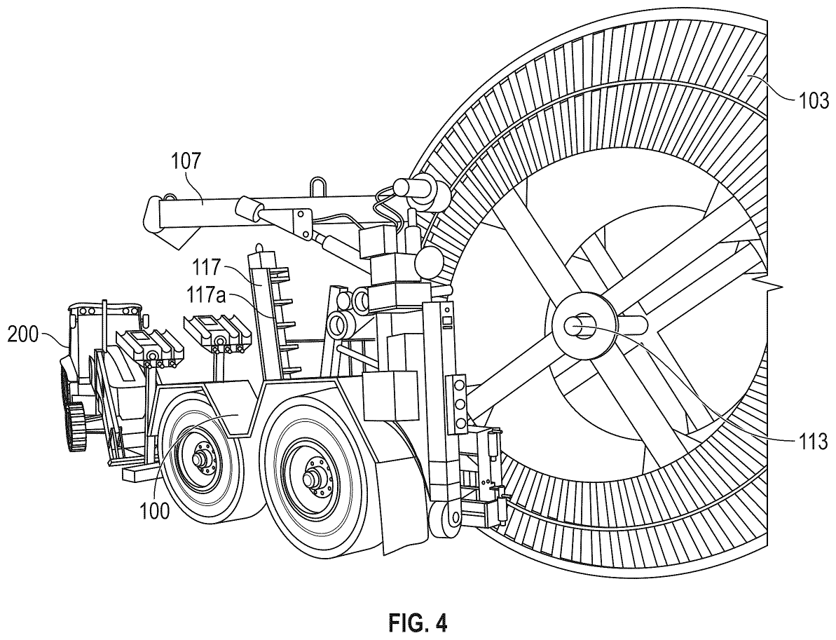

FIG. 4 illustrates an orthogonal view of the reel trailer 100 with the cable reel 103 positioned for loading. The reel trailer 100 includes a lift assembly 117 with an arbor slot 117a configured to receive the arbor 113. The hydraulic crane 107 is mounted to the reel trailer 100 and may be positioned to assist with the installation of the arbor 113 into the cable reel 103 prior to the cable reel 103 being loaded on the reel trailer. As shown in FIG. 4, the arbor 113 is installed in center of the cable reel such that the ends of the arbor 113 extend outwardly at substantially the same length to engage the lift assembly 117 on each side of the reel trailer.

In some implementations, the motorized vehicle 200 may be used to maneuver the reel trailer 100 such that the arbor 113 aligns with the arbor slot 117a of the lift assembly 117 on each side of the reel trailer. In some embodiments, a motorized vehicle with enhanced steering capabilities is provided to ensure the necessary alignment during the loading of the cable reel 103 onto the reel trailer 100.

In some embodiments, due to the weight of the arbor 113, the hydraulic crane 107 is used to lift and position the arbor 113 for insertion into the cable reel 103. In some embodiments, the hydraulic crane is configured to lift the arbor from a stored position on the reel trailer 100 and maneuver the arbor to a position adjacent the cable reel. Once the arbor 113 is inserted into a center hole of the cable reel 103, the motorized vehicle 200 may be used to back the reel trailer 100 up to the cable reel 103, allowing the arbor 113 to engage with the arbor slot 117a of the lift assembly 117.

Referring back to FIG. 3, the expanded reel trailer 100 may be hitched to the motorized vehicle 200 and positioned near the cable reel 103. The rear gate 111 of the reel trailer 100 is in an opened position to allow the reel trailer 100 to be backed up by the motorized vehicle 200 toward the cable reel 103. The reel trailer 100 is configured such that the cable reel 103 is received between the sides of the reel trailer 100 when the motorized vehicle 200 moves the reel trailer 100 into position. During transport of the reel trailer 100, a motorized vehicle 200 configured for roadway and highway usage is used to transport the reel trailer with or without the cable reel 103 installed. In some embodiments, due to the combined weight of the reel trailer and a cable reel, a heavy duty diesel powered logistics vehicle is used for transporting the reel trailer 100 on roadways and highways.

In some examples, the motorized vehicle 200 may be a tractor, wheel loader, or motorized power unit. The motorized vehicle 200 may have enhanced steering capabilities to facilitate precise positioning of the reel trailer 100 relative to the cable reel 103. In some embodiments, a self-propelled modular transport is connected to the hitch of the trailer to manipulate and drive the trailer for precise positioning relative to a cable reel 103 to be installed on the trailer. In some embodiments, the self-propelled modular transport is configured to move in any direction (360-degree steering), which is ideal for precise alignment when installing the cable reel on the reel trailer. In some embodiments, the self-propelled modular transport includes a radio transmitter and receiver such that an operator standing near the rear gate of the reel trailer has a direct line of sight to movable align the reel trailer relative to the cable reel 103 and ensure the arbor 113 is aligned with the lift assembly 117 on each side of the trailer.

FIG. 4 illustrates an orthogonal view of the reel trailer 100 with the cable reel 103 positioned for loading. The reel trailer 100 includes the lift assembly 117 with the arbor slot 117a configured to receive the arbor 113.

In some implementations, the motorized vehicle 200 may be used to maneuver the reel trailer 100 such that the arbor 113 aligns with the arbor slot 117a of the lift assembly 117. This alignment may facilitate the loading of the cable reel 103 onto the reel trailer 100. The hydraulic crane 107 may be used to lift and position the arbor 113 for insertion into the cable reel 103. Once the arbor 113 is inserted into the cable reel 103, the motorized vehicle 200 may be used to back the reel trailer 100 up to the cable reel 103, allowing the arbor 113 to engage with the arbor slot 117a of the lift assembly 117.

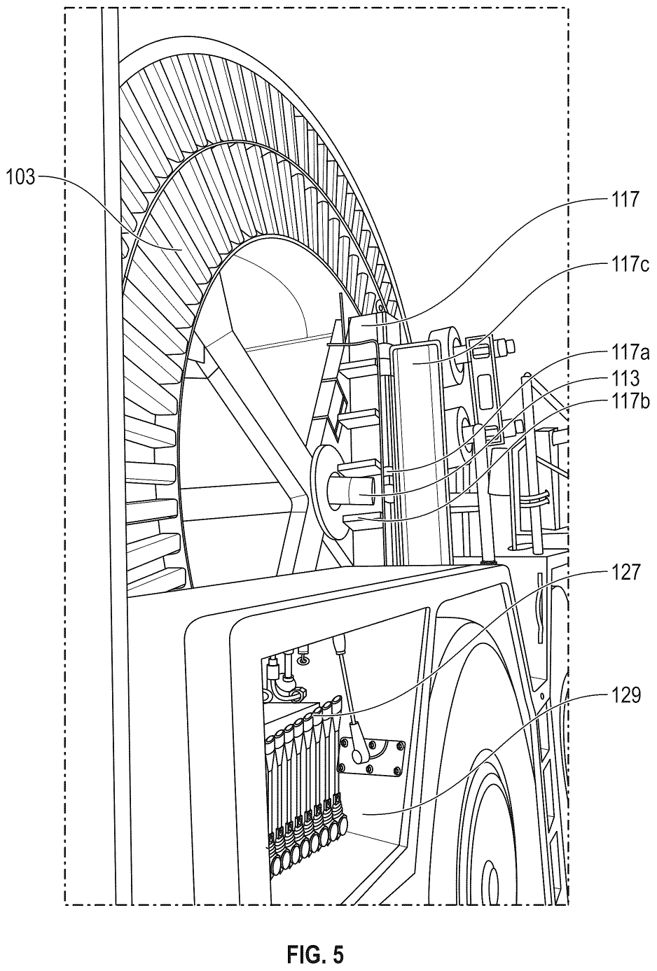

FIG. 5 illustrates a side view of a portion of the reel trailer 100 showing the arbor engaged with the lift assembly 117. The other side of the trailer has a lift assembly for receiving the other end of the arbor 113. The lift assembly 117 includes the arbor slot 117a configured to receive the arbor 113 that extends through the cable reel 103. A support ledge 117b may be positioned below the arbor slot 117a to provide support for the arbor 113 when loaded.

In some cases, a panel door 117c may be included as part of the lift assembly 117. The panel door 117c may be shown in an open position in FIG. 5. The panel door 117c is configured to secure the arbor 113 within the lift assembly 117 when closed. This configuration ensures that the cable reel 103 remains securely mounted on the reel trailer 100 during transport and operation.

The lift assembly 117 may be adjustable to accommodate different sizes of cable reels 103. In some implementations, control levers 127 may be positioned at a control panel 129 on the reel trailer 100. These control levers 127 may allow an operator to hydraulically adjust the lift assembly 117 to raise and lower the cable reel 103 during loading and unloading operations.

In this embodiment, the control panel 129 includes multiple control levers 127, each controlling different aspects of the lift assembly 117 or other components of the reel trailer 100. For example, one control lever 127 is used to adjust the height of the lift assembly 117, while another controls the opening and closing of the panel door 117c.

In some cases, the support ledge 117b is designed to distribute the weight of the cable reel 103 evenly across the lift assembly 117. This design helps reduce the risk of damage to the arbor 113 or the cable reel 103 during transport and operation.

In some embodiments, the arbor slot 117a is shaped to securely hold the arbor 113 while allowing for some degree of movement or rotation. This configuration facilitates the winding or unwinding of the cable 105 from the cable reel 103 when the reel trailer 100 is in use at a construction site.

In some embodiments, the lift assembly 117 is constructed from durable metallic materials capable of supporting the substantial weight of large cable reels 103. In some implementations, the lift assembly 117 is integrated into the frame 101 of the reel trailer 100, providing a stable and secure mounting point for the cable reel 103.

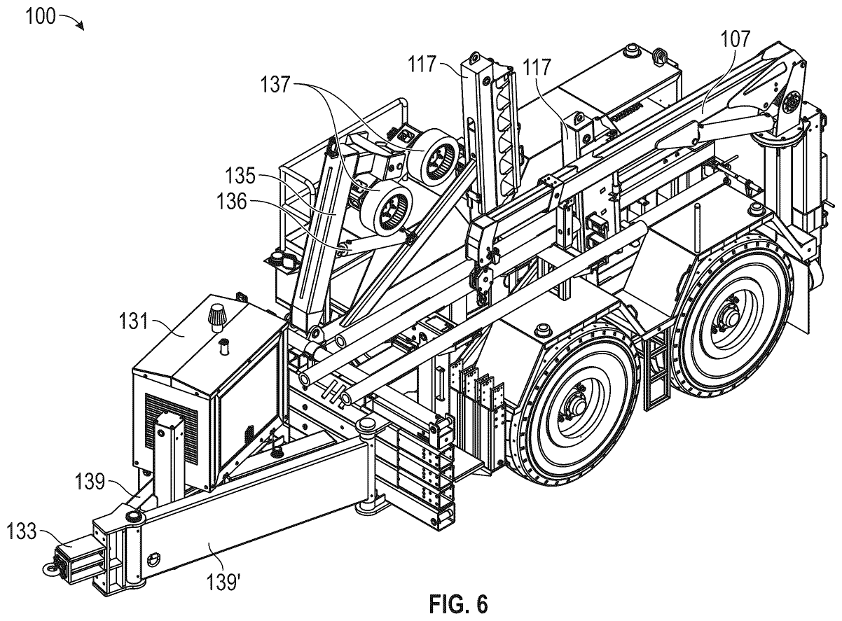

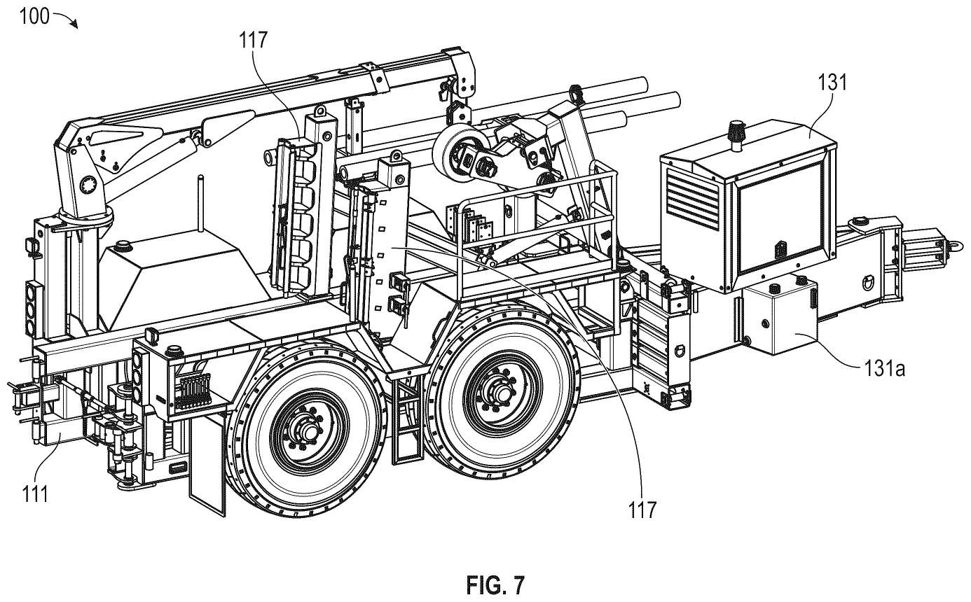

FIG. 6 illustrates an isometric view of the reel trailer 100 in a retracted state. The reel trailer 100 includes a hitch 133 at the front end for connecting to the motorized vehicle 200. An engine 131 is mounted near the front of the reel trailer 100 on one of the hitch weldments 139, 139'. The hitch weldments 139, 139′ may form a triangular configuration at the front of the reel trailer 100. The rear gate 111 is stored between the left and right frame sides in the retracted state (FIG. 7).

As shown in FIG. 6, a rim drive arm 135 is provided on the reel trailer 100, which includes drive wheels 137. In some cases, the drive wheels 137 are provided as a pair and made of rubber or polyurethane. The rim drive arm 135 is configured to pivotable move via hydraulic cylinders 136. In some embodiments, the hydraulic crane 107 is mounted on a side of the reel trailer 100 near the rear portion. In some embodiments, the reel trailer 100 may also include the lift assemblies 117 positioned on opposite sides for supporting the cable reel 103.

FIG. 7 shows a side view of the reel trailer 100. The engine 131 is mounted near the front portion of the reel trailer 100 at the hitch end. A hydraulic tank 131a may be positioned below the engine 131. The engine 131 and hydraulic tank 131a may be integrated into the frame 101 of the reel trailer 100, with the hydraulic tank 131a being mounted in a lower position. In some embodiments, a diesel fuel tank is mounted on the hitch on a side opposite the engine 131.

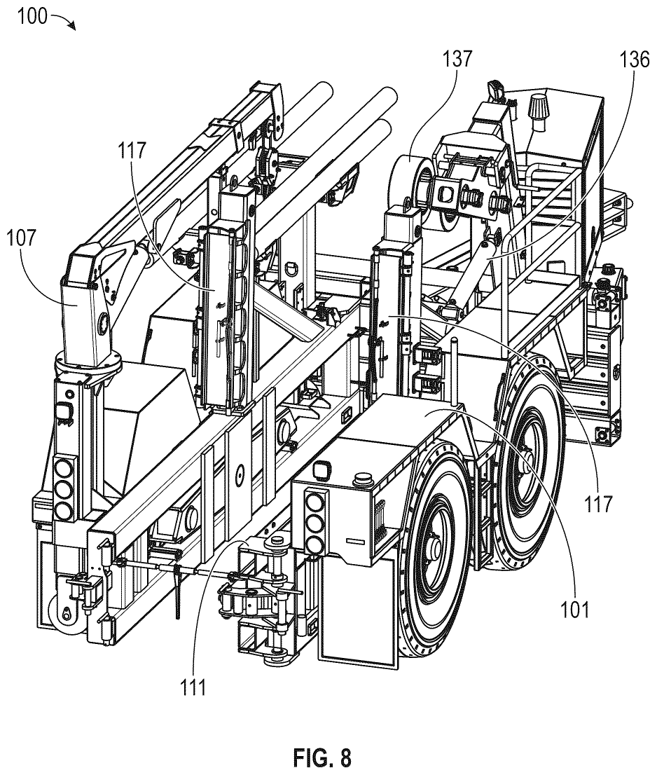

FIG. 8 illustrates a rear orthogonal view of the reel trailer 100 in the retracted state. The frame 101 may be shown in a closed configuration where the left and right sides are brought together to achieve a compact width for transport or storage. In some embodiments, the rear gate 111 is mounted such that it is positioned against the one side of the frame 101 in a stowed position.

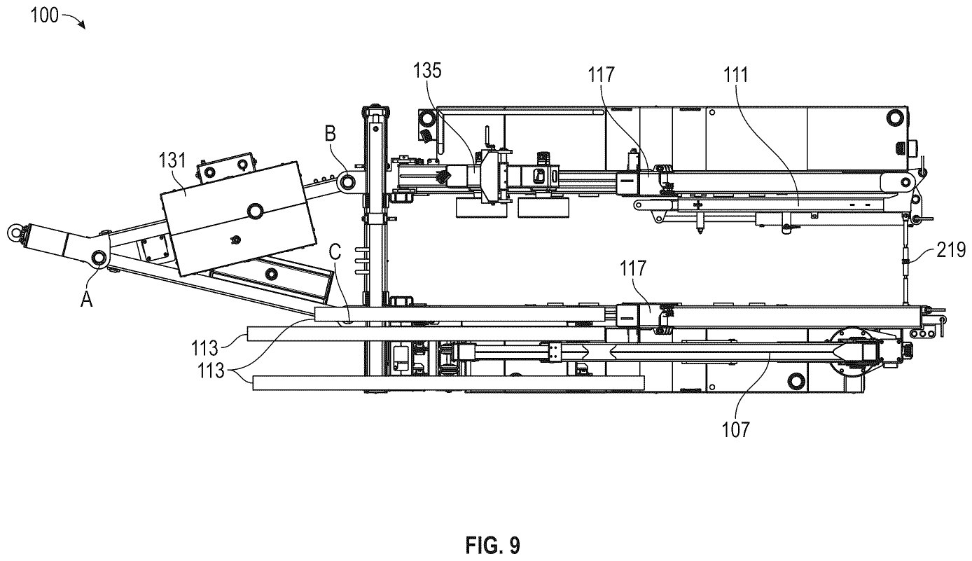

FIG. 9 illustrates a top orthogonal view of the reel trailer 100 in the retracted state. The reel trailer 100 includes the frame 101 with the rear gate 111 positioned at the back end. The engine 131 is mounted near the front of the reel trailer 100. The rim drive arm 135 may be disposed on one side of the reel trailer 100, while the lift assembly 117 may be positioned on the opposite side. The hydraulic crane 107 is mounted on one side of the reel trailer 100 near the rear gate 111. As shown in FIG. 9, different size arbors 113 are stored on the reel trailer 100 when not in use and are retrieved by the hydraulic crane 107 when needed for insertion into a cable reel 103.

In some cases, the reel trailer 100 in the retracted state may have dimensions of approximately 10 feet in height, 27 feet in length, and 8.5 feet in width. These compact dimensions may allow for efficient transport and storage of the reel trailer 100 when not in use. In some embodiments, a weight of the reel trailer without a cable reel load has a gross vehicle weight of about 20,000 to about 30,000 pounds.

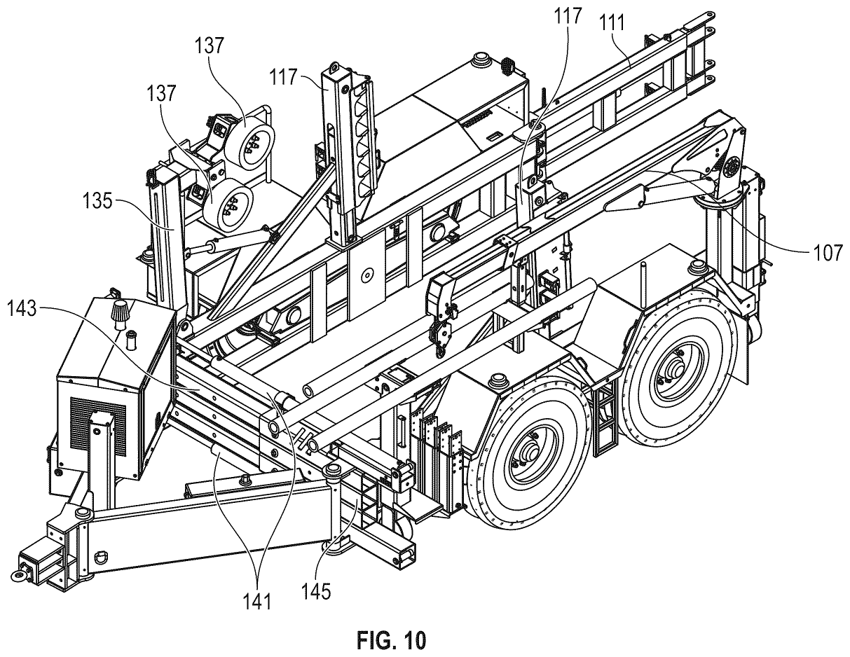

FIG. 10 illustrates an isometric view of the reel trailer 100 in an expanded state with the rear gate 111 in an open position. The reel trailer 100 includes an expandable frame configuration designed to accommodate cable reels 103 of various sizes. In some examples, the expandable frame configuration includes a hydraulic cylinders 141 and extension beams 143 and 145. In some embodiments, the extension beams 143 and 145 are positioned near the front of the reel trailer 100 and configured to slide to adjust the width of the frame 101. The hydraulic cylinders 141 is configured to control the movement of the extension beams 143 and 145, allowing the frame 101 to expand or retract as needed. As described with respect to FIG. 2, one side of the reel trailer is elevated to facilitate expansion of the trailer width using ground plates 121 and jack outriggers 119.

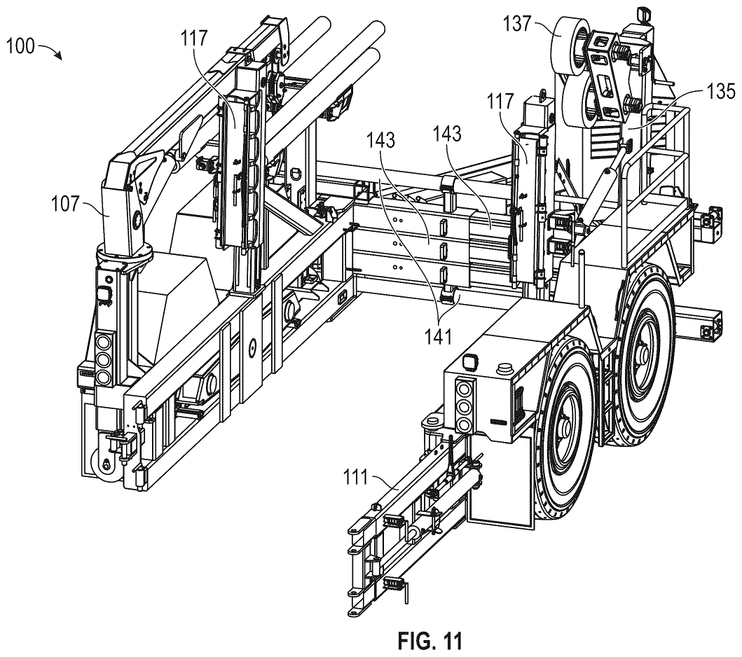

FIG. 11 provides another isometric rear view of the reel trailer 100 in its expanded configuration. In some embodiments, the rear gate 111 is in an open position, extending outward from one side of the reel trailer 100. The hydraulic cylinders 141 may be connected to the extension beams 143 and 145, enabling controlled width adjustment of the frame 101. In some implementations, the extension beams 143 and 145 are arranged in a sliding configuration near the front portion of the reel trailer 100. This arrangement may allow for smooth and stable expansion and contraction of the frame 101. In some embodiments, the left frame side of the reel trailer is extended in a direction away from the right frame side of the trailer. In other words, the right side of the reel trailer remains in position while the left side is movable adjusted to accommodate a specific cable reel 103.

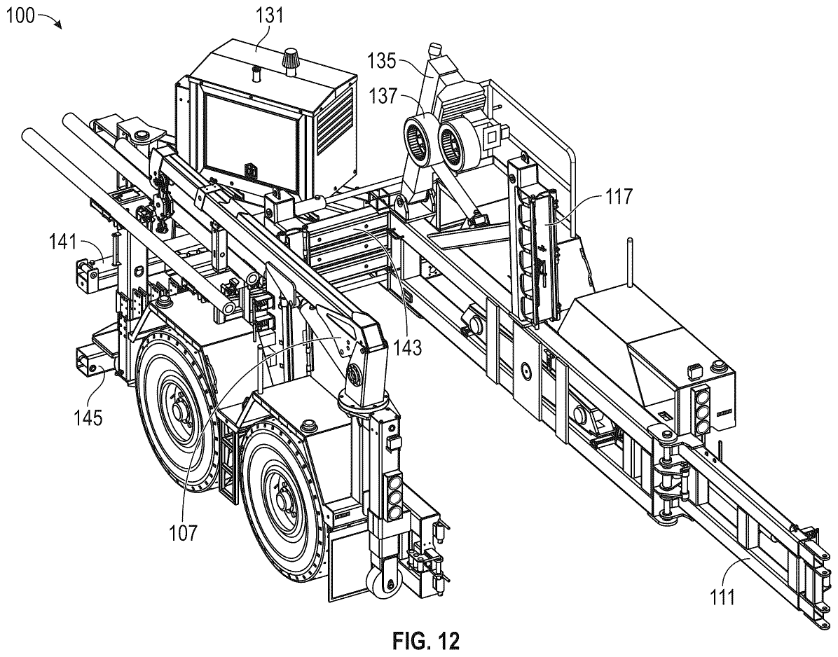

FIG. 12 illustrates a rear view of the reel trailer 100 in its expanded state. The rear gate 111 may be shown in an open position, providing access to the expanded frame area. The hydraulic cylinders 141 are visible, illustrating their role in the width adjustment mechanism of the reel trailer 100. In FIG. 12, the extension beams 143 and 145 are shown in their extended positions, demonstrating how the reel trailer 100 may accommodate different-sized cable reels 103. In some embodiments, the extension beams 143 and 145 work in conjunction with the hydraulic cylinders 141 to provide stable support during the expansion and retraction of the reel trailer 100.

The expandable frame configuration may allow the reel trailer 100 to adjust its width to suit various cable reel 103 sizes while maintaining structural integrity. In some implementations, the hydraulic cylinder 141 may be controlled via the control panel 129, allowing an operator to adjust the width of the reel trailer 100 as needed.

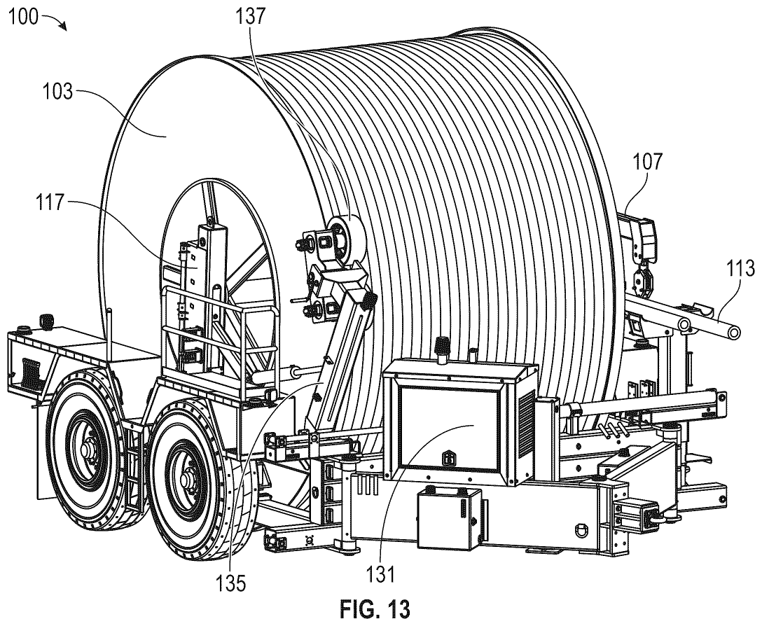

FIG. 13 illustrates a perspective view of the reel trailer 100 in an expanded configuration with the cable reel 103 securely mounted on the lift assembly 117. The reel trailer 100 includes the lift assembly 117 on each side that supports the arbor 113, which passes through the center of the cable reel 103. The lift assembly 117 is configured to raise and lower the arbor 113 to facilitate loading and unloading of the cable reel 103.

In some cases, the cable reel 103 may be positioned between the expanded sides of the frame 101 of the reel trailer 100. The arbor 113 may be securely engaged in the lift assembly 117 to maintain the cable reel 103 in an elevated position for transport and operation.

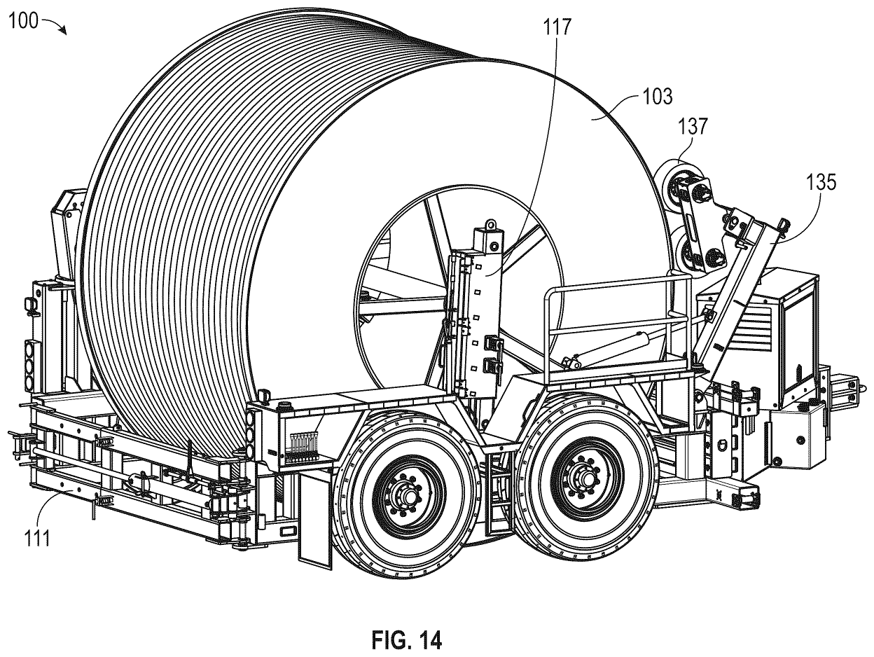

FIG. 14 presents a side orthogonal view of the reel trailer 100 with the cable reel 103 mounted on the reel trailer 100. The reel trailer 100 is shown in an expanded configuration to accommodate the cable reel 103, which may be secured in position on the reel trailer 100. The cable reel 103 is mounted centrally between the expanded sides of the reel trailer 100, allowing for stable transport and operation. In FIG. 14, the rear gate 111 is shown in a closed and locked state.

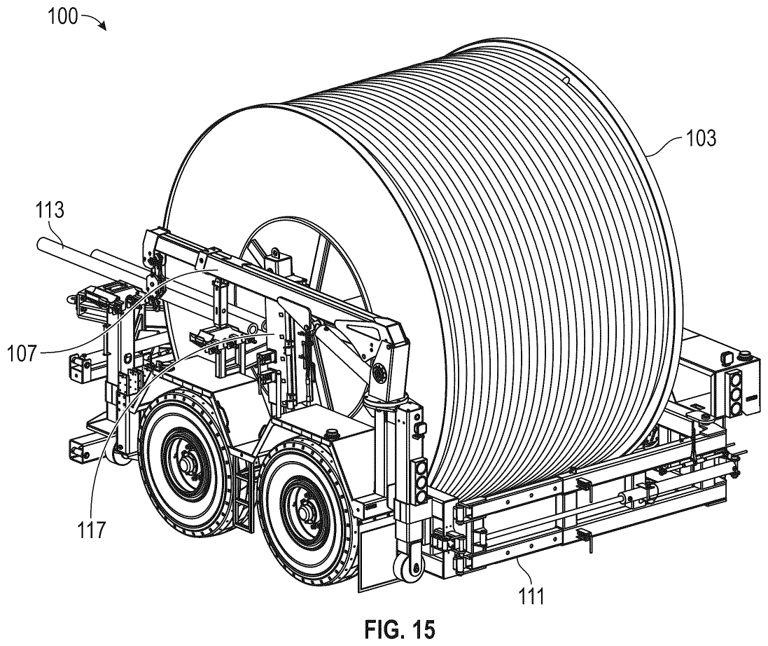

FIG. 15 illustrates an isometric view of the reel trailer 100 in an expanded configuration with the cable reel 103 mounted. The frame 101 of the reel trailer 100 is expanded laterally to accommodate the cable reel 103, which is positioned between the expanded sides of the frame 101. The cable reel 103 is mounted centrally on the reel trailer 100 in a horizontal orientation, allowing for rotation during cable winding or unwinding operations. In some embodiments, the expanded frame 101 of the reel trailer 100 provides substantial support for the cable reel 103, demonstrating the load-bearing capability of the reel trailer 100. The expanded configuration may allow for proper clearance and stability during use.

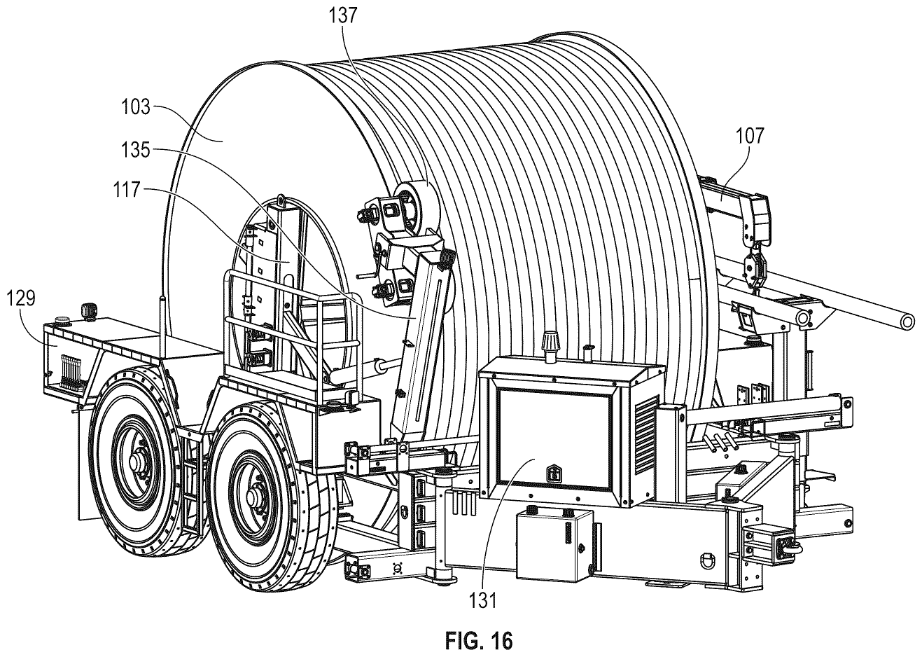

FIG. 16 provides another isometric view of the reel trailer 100 configured for transporting and handling the cable reel 103. The cable reel 103 may be positioned centrally on the reel trailer 100 and may appear to be secured in place by mounting components on either side of the frame 101. In some embodiments, the cable reel 103 is a large industrial-sized reel suitable for carrying substantial lengths of cable. The proportions and scale of the cable reel 103 relative to the frame 101 of the reel trailer 100 may indicate that the reel trailer 100 may be designed for heavy-duty applications.

In some embodiments, the reel trailer 100 provide a platform for supporting and transporting the cable reel 103, with the expanded configuration enabling proper clearance and stability during use. The lift assembly 117, the expanded frame 101, and rear gate 111 work together to securely hold the cable reel 103 in place during transport and operation.

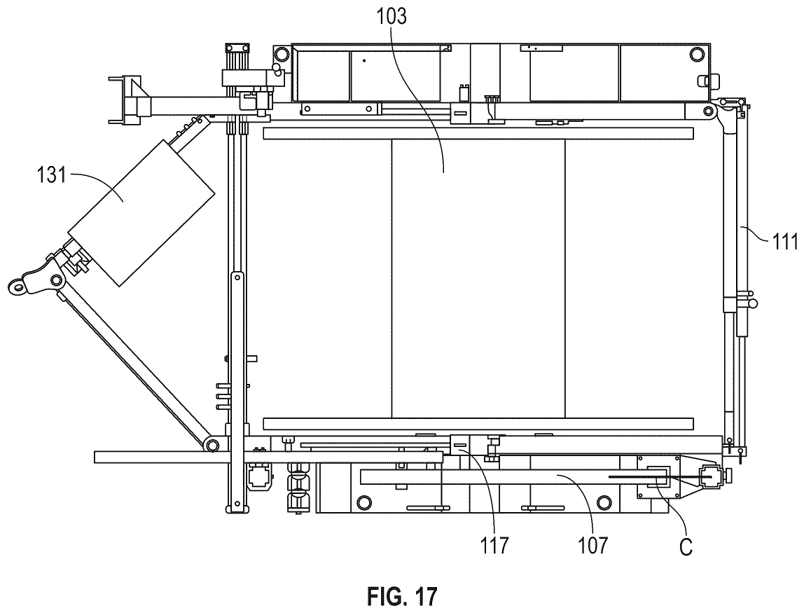

FIG. 17 illustrates an orthogonal side view showing the operational reach of the hydraulic crane 107. The hydraulic crane 107 is mounted to the frame 101 of the reel trailer 100. In some cases, the hydraulic crane 107 may have a radial reach capability from a center point labeled “C” on the reel trailer 100.

The hydraulic crane 107 is configured with specific operational parameters. In some implementations, the hydraulic crane 107 may have a 30,000 ft-lb crane rating. In some embodiments, the hydraulic crane 107 is configured for 400 degrees of rotation, allowing for extensive coverage around the reel trailer 100. The boom angle of the hydraulic crane 107 may range from 15 degrees to 73 degrees, providing flexibility in lifting and positioning operations.

In some cases, the radial reach of the hydraulic crane 107 from the center point C may be 16 feet. In other implementations, the radial reach may extend to 20 feet, allowing the hydraulic crane 107 to access a larger area around the reel trailer 100. This extended reach may facilitate the retrieval and handling of the arbor 113 and other components of the reel trailer 100 during loading and unloading operations. In some embodiments, the hydraulic crane 107 is used to retrieve ground plates 121 stored on the trailer and position them alone a side of the trailer during width adjustment (FIG. 2)

In some embodiments, the hydraulic crane 107 has specific dimensional characteristics. In some implementations, the storage height of the hydraulic crane 107 is approximately 37 inches. This compact storage height may allow for efficient transport of the reel trailer 100. In some embodiments, the hydraulic crane 107 may have a lift height of approximately 18 feet, enabling the handling of tall cable reels 103 or reaching elevated positions during operation. In some embodiments, the overall storage length of the hydraulic crane 107 is approximately 161 inches.

The range of motion and reach capabilities of the hydraulic crane 107 allows for versatile handling of the arbor 113 and other components of the reel trailer 100. In some cases, the hydraulic crane 107 may be used to lift and position the arbor 113 for insertion into the cable reel 103 during loading operations. The extensive rotation and boom angle range may enable accurate positioning of components around the reel trailer 100.

A further description of the frame 101 and other components of the reel trailer 100 trailer are provided below. In certain embodiments, the frame 101 of the reel trailer 100 includes heavy-duty mild steel plates and weldments designed to handle the torque of the drive system and the weight of the trailer with and without the cable reel 103 installed. In some embodiments, the structural integrity and versatility of the reel trailer 100 relies on the interaction between a main frame weldment and plating that allows for both braking and width adjustment.

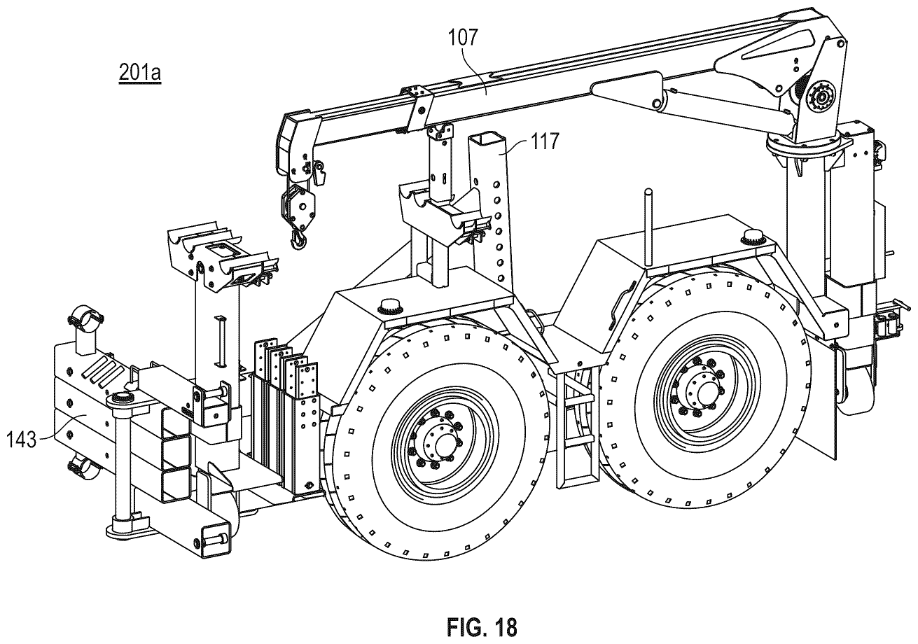

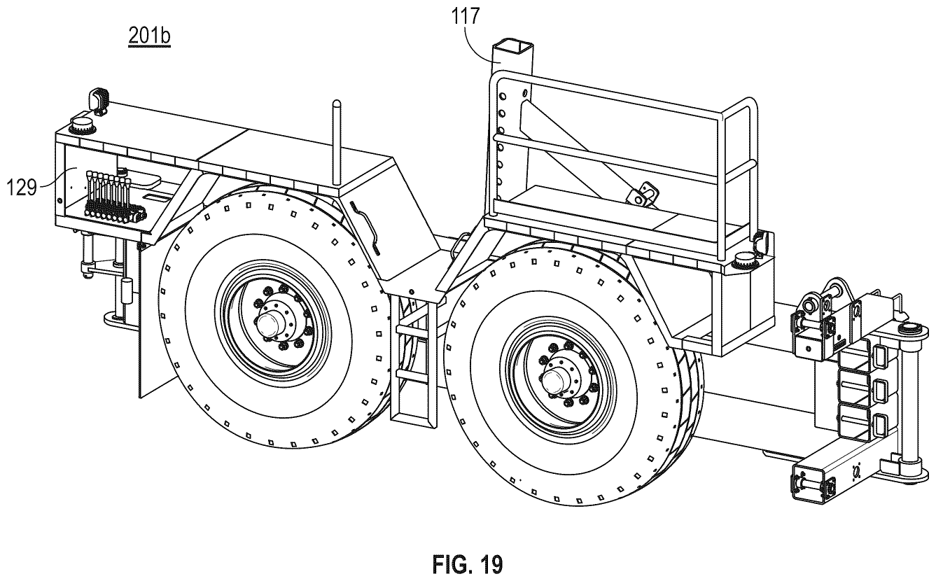

In some embodiments, the left and right side frame assemblies (200, 201), illustrated FIG. 18 and FIG. 19, serve as a foundation. In some embodiments, frame expansion includes a high-strength sliding interface (e.g., extension beams 143 and 145) that enables the trailer to expand or contract. To facilitate this movement, in some embodiments, expansion hydraulic cylinders 141 provide the anchored pivot points to push one frame assembly away from the other.

While the frame 101 of the reel trailer 100 handles the load, brake rotor mounts on the wheel assembly are precision-welded to the left and right frame assemblies 201a, 201b to ensure that a caliper stays aligned with the rotor, ensuring consistent stopping power even under heavy loads. In some embodiments, a tandem stopper plate acts as a safety boundary, providing a physical steel stop that prevents the axle assemblies from over-extending during travel or adjustment, effectively locking the geometry of the structural components together. In certain embodiments, the material used for the plates are cut from a carbon structural steel such as American Society for Testing and Materials (ASTM) A36 mild steel or equivalent, which is ideal for its weldability and structural predictability. In some embodiments, the expansion and mounting beams range from about ⅜ inch to about ¾ inch, ensuring that the frame does not flex or “cock” when the hydraulic cylinders 141 are pressurized. In some embodiments, the beams are joined using a combination of deep-penetration welds and grade 8 high-strength bolts, such as the ⅝″-11 screws to handle the shear forces generated by the weight of the trailer.

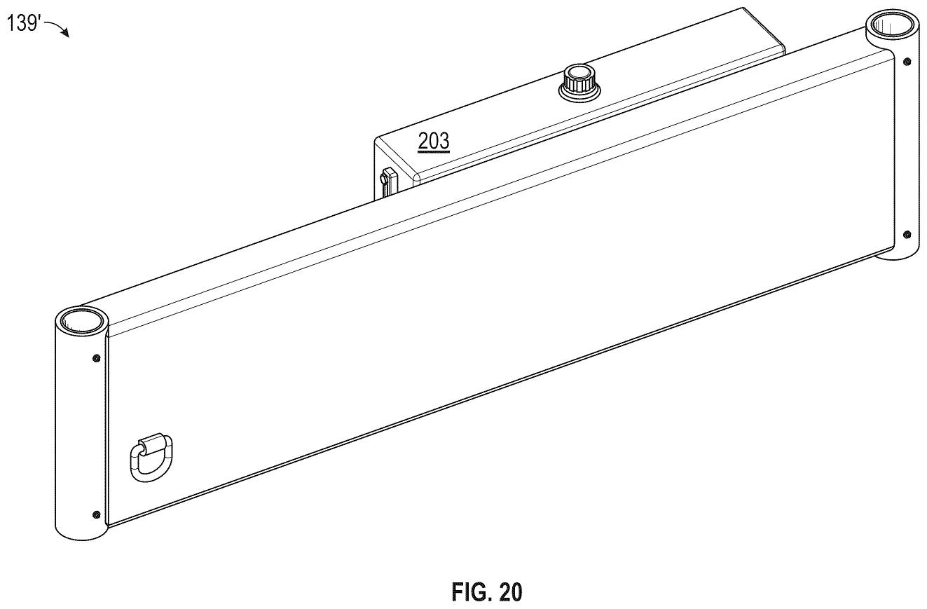

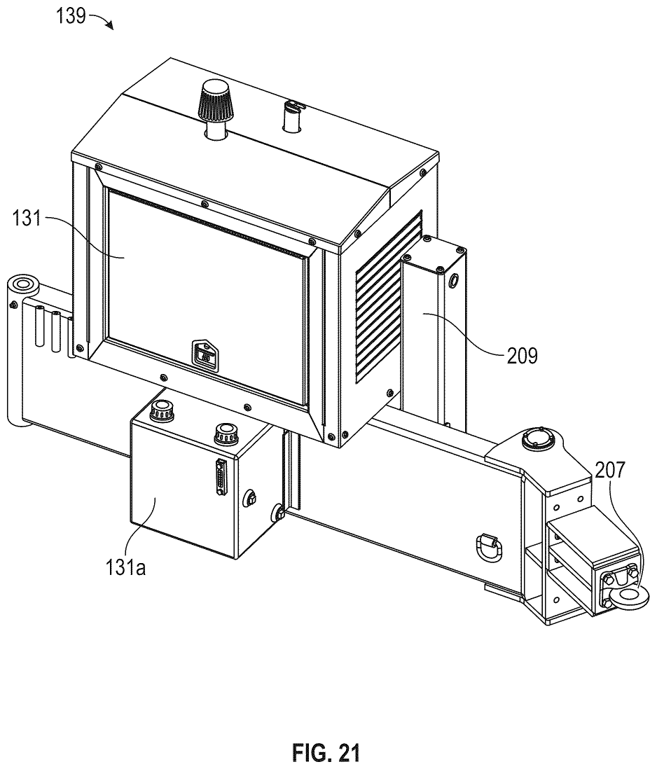

In some embodiments, the hitch weldments 139, 139′ form a triangular configuration at the front of the reel trailer 100 (FIG. 10). As shown in FIG. 20, the hitch weldment 139′ houses a hydraulic fluid reservoir 203. As shown in FIG. 21, the hitch weldment 139 houses the engine 131 and hydraulic tank 131a. In other embodiments, although not shown, a fuel tank is provided on the one or both of the hitch weldments 139, 139′ for powering the engine 131. In some embodiments, the hitch is engineered to manage the significant weight and hydraulic demands of the reel trailer 100, primarily through the interaction of a hitch weldment and one or more integrated hydraulic reservoirs/tanks. In some embodiments, one or more aluminum hydraulic tanks are mounted to provide a steady supply of fluid to the jack and expansion cylinders, while the engine 131 powers the entire system. The hitch weldment serves as the primary structural arm, terminating at the drawbar ring 207, which provides the mechanical link to the motorized vehicle 200 (FIG. 3). In some embodiments, to stabilize the reel trailer 100 when detached or stationary, a jack inside tube weldment 209 (FIG. 21) slides within the hitch assembly, driven by a jack cylinder. In some embodiments, this hydraulic ram provides the vertical force necessary for leveling the trailer.

In some embodiments, when the reel trailer 100 is under load with the cable reel 103, the weight is distributed through the hitch weldment and stabilized by the jack assembly. In some embodiments, hardware such as ⅞″ bolts ensures that the mounting points for the engine 131 and the hydraulic tank(s) 205 can withstand the vibrations of operation and the stresses of roadway and highway travel. In some embodiments, the system is designed so that the weight of the hydraulic fluid and engine actually aids in providing downward pressure on the hitch, improving towing stability.

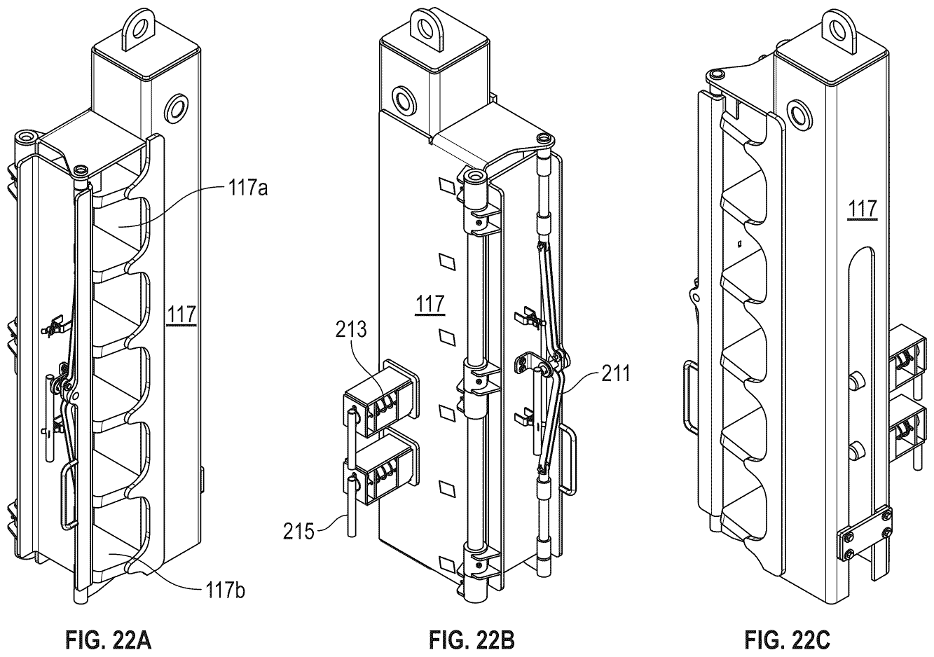

FIGS. 22A, 22B, and 22C provide three different views of the lift assembly 117. As shown in at least FIG. 8 above, the reel trailer 100 includes a left side and a right side lift assembly 117. The following description is applicable to both the left and right side lift assemblies 117. The pair of lift assemblies 117 operate as a heavy-duty mechanical linkage designed to transform hydraulic pressure into controlled vertical and angular movement. The lift assembly 117 is a heavy-duty structural sub-assembly that functions as the primary “elevator” for the reel trailer's cargo (i.e., cable reel 103). In some embodiments, the lift assembly 117 is a dynamic component that physically interacts with the cable reel 103, allowing it to be raised for transport or lowered to the ground for loading and unloading, eliminating the need for external cranes or ramps. In some embodiments, the lift assembly 117 provides load stabilization during transport once the cable reel 103 is lifted. The lift assembly 117 is configured as a rigid cradle and because it is fastened to the frame of the reel trailer at multiple points, it locks the cable reel 103 into the reel trailer's center of gravity. This helps prevent the cable reel 103 from shifting laterally or bouncing independently of the reel trailer's suspension, which is important for highway safety.

In some embodiments, the lift assembly latch bar 211, lock pins 215, and springs 213 are configured as fail-safe components. For example, if a hydraulic hose were to fail, the mechanical latches are designed to prevent lift assembly from falling unexpectedly. Furthermore, in some embodiments, stainless steel clevis pins are provided in the smaller linkage points ensuring that pivot areas do not seize up due to rust or road salt, maintaining the system's mobility over time.

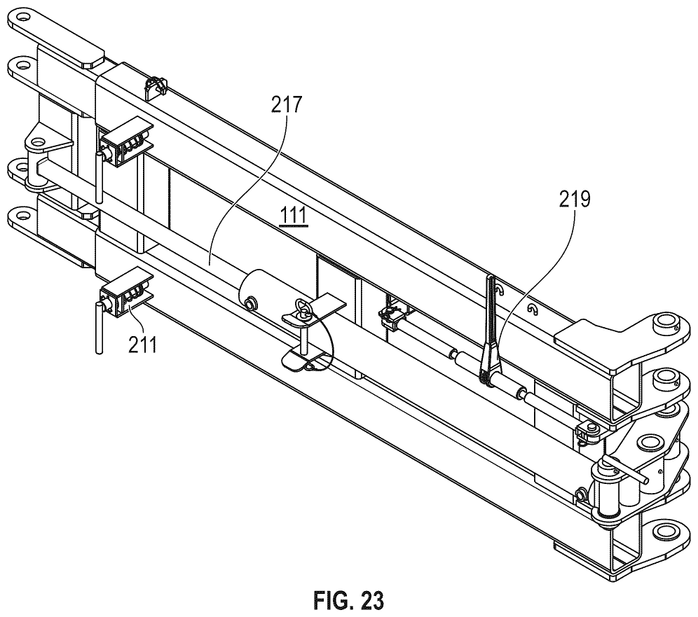

FIG. 23 illustrates a detailed view of the rear gate 111. The rear gate 111 is configured as a structural and safety component located at the back of the reel trailer 100. While the rear gate 111 serves as a functional door for loading and unloading, it is also a structural tie that completes the reel trailer's box frame, preventing the side rails from splaying outward under the weight of a heavy load of a cable reel 103. In some embodiments, the rear gate 111 is a reinforced weldment designed to handle significant mechanical stress and integrate with the reel trailer's hydraulic and locking systems. In some embodiments, the rear gate is constructed from heavy-wall square or rectangular steel tubing, forming the outer perimeter of the gate to resist twisting.

In some embodiments, heavy-duty cylindrical steel sleeves are welded to the side of the rear gate 111. These house the pins that allow the gate to swing or pivot during operation. In some embodiments, precision-welded tabs provide the anchor point for the tailgate cylinder 217. This allows the hydraulic system to push the rear gate 111 open or pull it closed. In some embodiments, hardened steel plates are provided to engage with a gate-latch bar or load binder 219. These ensure the gate remains physically locked even if hydraulic pressure is lost. In some embodiments, reinforcement plates are welded at the corners of the tubing to prevent the rear gate from “diamonding” (losing its square shape) over time. In some embodiments, the reel trailer 100 is designed to pick up cable reels 103 directly from the ground, and the rear gate 111 is to be moved out of the way. In some embodiments, the hydraulic cylinder 217 allows the rear gate to open to provide a clear path for the lift assembly to lower to ground level. In some embodiments, once the cable reel 103 is inside the trailer, the gate is hydraulically closed to secure the rear perimeter.

In some embodiments, the rear gate 111 is configured as a barrier for the cable reel. In some embodiments, the rear gate 111 together with the lift-lock pin springs 221 and the load binder 219, ensures that the cable reel cannot slide out the back of the trailer during steep climbs or sudden acceleration. In some embodiments, the rear gate serves as the mounting surface for the rear safety lighting, including a brake light and backup light, ensuring the reel trailer 100 remains visible and legal on public roads. In some embodiments, the load binder 219 is configured as a manual tensioning and safety component used to secure the rear gate and stabilize the reel trailer's structural box shape during transport.

In some embodiments, while the hydraulic cylinder 217 move the heavy components of the rear gate, the load binder 219 provides the mechanical fail-safe and high-tension clamping force required for high-speed travel and heavy-load stability. In some embodiments, lock pins are used to lock the tailgate in position. In some embodiments, the load binder 219 provides a horizontal “squeeze.” In some embodiments, when the reel trailer is in a retracted state (FIG. 8), the load binder is used to secure the rear end of the trailer. By tensioning the binder across the rear of the reel trailer 100, the operator physically pulls the left and right frames tight against the rear gate, creating a rigid, unified structure that is resistant to flexing or widening while hitting bumps at highway speeds. Hydraulic cylinders, such as tailgate cylinder 217 can leak down over extended periods or lose pressure if a hose is damaged. In some embodiments, the load binder 219 acts as a mechanical lock. In some embodiments, the load binder 219 is positioned in a stowed position when not in use, such as during transport mode of the loaded reel trailer.

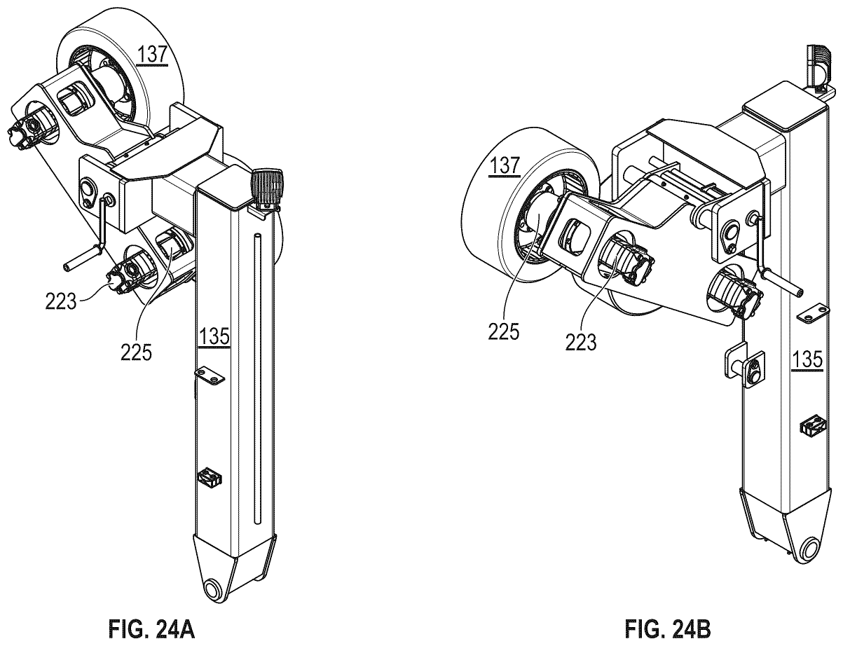

FIGS. 24A and 24B are different views of the rim drive arm 135 and drive wheels 137. In some embodiments, the rim drive arm 135, drive wheels 137, and hydraulic cylinder 136 (FIG. 6) form a specialized friction-drive system designed to rotate the cable reel 103 directly rather than driving the arbor 113. This is particularly useful for controlled dispensing or retracting of heavy utility cable.

In some embodiments, the rim drive arm 135 is a heavy-duty structural weldment or assembly that functions as a pivoting lever. The rim drive arm 135 is mounted to the main frame of the reel trailer 100, allowing it to move in an arc. In some embodiments, this pivoting action is allows the system to adjust for different reel diameters—swinging in for smaller cable reels 103 and out for a larger cable reel 103. In some embodiments, the rim drive arm 135 houses the a hydraulic motor 223 and gear reducer 225. By mounting these components directly on the arm drive assembly, the power source stays aligned with the drive wheels 137 regardless of the arm drive assembly's position.

In some embodiments, the drive wheels 137 are the primary contact with the cable reel 103. In some embodiments, the drive wheels 137 are a high-traction, solid polyurethane tires. In some embodiments, polyurethane provides a high coefficient of friction and is able to withstand extreme compression without deforming permanently. The drive wheels 137 are pressed against the outer rim or flange of the cable reel 103. As the hydraulic motor 223 turns the drive wheels 137, friction transfers the rotational energy to the reel flange, causing the entire reel 103 to rotate.

In some embodiments, the hydraulic cylinder 136 (FIG. 6) acts as the clutch and pressure regulator for the rim drive arm 135. In some embodiments, the hydraulic cylinder 136 provides constant hydraulic force. This force is ideal because cable reels 103 are rarely perfectly circular; they may be warped or have irregular flanges. In some embodiments, the hydraulic cylinder 136 acts as a tensioner, allowing the rim drive arm 135 to move slightly in and out to maintain constant contact pressure as the cable reel 103 rotates. In some embodiments, when the rim drive arm 135 is no longer needed, the hydraulic cylinder 136 retracts, pulling the rim drive arm 135 away so the reel can freewheel or be locked in position.

In some embodiments, the reel trailer 100 includes an axle and suspension system (not shown) engineered to distribute the trailer's weight evenly across the ground while providing the structural flexibility needed for off-road or uneven terrain. In some embodiments, the system is centered around an axle weldment, which includes a heavy-duty structural steel tube that spans the width of the reel trailer. In some embodiments, this weldment serves as the mounting foundation for hub and spindle assemblies for the main transport tires 123. In some embodiments, the spindles are precision-machined components that are either bolted or welded into the ends of the axle tube, providing the high-strength rotating axis for the trailer tires 123. In some embodiments, in order to manage the vertical loads and road vibrations, the system utilizes a tandem axle configuration supported by leaf springs. In some embodiments, these multi-leaf springs are composed of stacked layers of high-tensile spring steel, which flex under load to absorb shocks. In this tandem setup, the springs are connected via an equalizer linkage that allows the front and rear axles to move independently over bumps while maintaining equal weight distribution. This interaction is important; as one wheel rises over an obstacle, the leaf spring compresses and transfers a portion of that energy through the equalizer to the other axle, preventing the frame from twisting or hopping. In some embodiments, the suspension assembly is integrated with braking and frame limits. In some embodiments a tandem stopper plate interacts directly with the suspension's path of travel to ensure the axles do not over-rotate or strike the frame during extreme articulation. In some embodiments, brake discs are mounted directly to the hubs, meaning the braking force is applied at the very point where the wheels meet the spindles. This creates a cohesive unit where the axle provides the structure, the springs provide the cushion, and the hubs provide the rotation and stopping interface.

In some embodiments, the engine 131 (FIG. 21) serves as the primary power source for the reel trailer 100, transforming it from a passive towed vehicle into a self-contained, active machine. In some embodiments, the reel trailer 100 features a hydraulic drive system, a high-torque lifting mechanism, and an expansion frame, and therefore requires a significant and constant source of pressurized fluid. In some embodiments, the engine's 131 purpose is to drive the hydraulic pumps that feed the system, allowing the operator to lift heavy loads, and adjust its width without needing the tow vehicle to be running or even attached.

In some embodiments, the engine 131 is mounted to the hitch assembly (FIG. 21) using high-strength hardware such as bolts and vibration-dampening mounts. In some embodiments, this placement puts the weight of the engine over the hitch to improve towing stability and places the power source in close proximity to the hydraulic tank(s) and fuel tank(s). By being directly coupled to the hydraulic pump, the engine creates the flow and force required to actuate the hydraulic drive motors for propulsion and lifting operations.

In some embodiments, the expandable frame of the reel trailer 100 includes hydraulic cylinders 141 and extension beams 143 and 145 (FIG. 12). In some embodiments, the extension beams 143 and 145 are positioned near the front of the reel trailer 100 and configured to slide to adjust the width of the frame 101. In some embodiments, the expandable frame configuration is a mechanical feature that allows the reel trailer 100 to transition between a narrow transport mode (for roadway/highway travel) and a wide loading mode to house and transport large cable reels 103. In some embodiments, this operation is driven by a hydraulics integrated into the front end of the trailer.

In some embodiments, the width adjustment feature of the reel trailer 100 depends on the interaction between hydraulic cylinder 141 which is the prime mover of the expansion system. In some embodiments, the hydraulic cylinder 141 is a double-acting hydraulic ram mounted transversely (horizontally) across the front of the trailer. In some embodiments, it is anchored to the stationary portion of a mid-beam weldment or a central structural member. In some embodiments, extension beam 143 is a structural steel box-section beam that is nested within the main front cross-member and bolted to a left main frame weldment. In some embodiments, extension beam 145 (right side) is a mirror-image counterpart to beam 143, bolted to a right main frame weldment.

In some embodiments, the expansion of the frame width of the reel trailer follows a mechanical sequence of operations. The following provides additional description of the operation illustrated in FIG. 2. In some embodiments, when the operator activates the expansion control, by way of a radio remote or manual control at the control panel 129, the engine 131 sends pressurized fluid to the hydraulic cylinders 141. In some embodiments, as the hydraulic cylinder 141 extends, it applies equal and opposite force to the extension beams 143, 145, allowing these beams to slide outward within the primary frame housing. In some embodiments, a telescopic interface ensures smooth movement, with the beams 143, 145 sliding against expansion plates or high-density wear pads. In some embodiments, this reduces steel-on-steel binding and ensures that the beams do not cock or jam. In some embodiments, the hydraulic cylinder 141 provides enough force to overcome the weight of the side frames. To make this easier, in some embodiments, the operator utilizes the jack outriggers 119 to lift one side of the trailer slightly, reducing ground friction. As shown by the bi-directional arrows 118 (FIG. 2) positioned between the bottom surface of tires 123 and the ground surface 125, an elevated distance off the ground surface is provided by the lift. In some embodiments, each jack outrigger 119 includes an outrigger wheel 119a (FIG. 2) that enables controlled movement during the width adjustment process. In some embodiments, the reel trailer 100 includes ground plates 121 (FIG. 2) that can be positioned on a ground surface 125 using the hydraulic crane. In some embodiments, the ground plates 121 provide a stable path for the outrigger wheels 119a to roll along during expansion of the reel trailer 100. In some embodiments, once the desired width is reached—allowing the reel trailer 100 to straddle the cable reel 103—the hydraulic valves are closed, thereby locking the fluid in the cylinder to maintain the position.

In some embodiments, to allow the reel trailer to back up toward the cable reel 103, the rear path is cleared. The tailgate cylinder 217 is actuated to open the rear gate 111. Once the trailer is positioned, a heavy-duty arbor 113 (the bar passing through the center of the cable reel) is hydraulically aligned with the support ledges 117b of the lift assembly 117 (FIG. 5). In some embodiments, the lift assembly 117 is specifically designed with arbor slot 117a that capture the ends of the arbor 113. With the arbor seated, the cylinders are extended thereby pulling the lift assembly 117 upward, pivoting on high-strength pins. As the lift assembly 117 rises, it carries the weight of the cable reel 103 until the reel is suspended within the trailer chassis. Once the lift reaches the transport height, the lift-lock pin springs fire the safety pins into place, mechanically locking the lift frame so the hydraulic system is no longer carrying the weight.

In some embodiments, the addition of the hydraulic crane 107 and the telescopic mast pole light 109 transforms the reel trailer 100 from a transport vehicle into a self-contained mobile worksite. In some embodiments, these components are strategically mounted near the rear gate 111 (FIG. 1) to maximize their utility during cable installation and nighttime operations.

In some embodiments, the hydraulic crane 107 is mounted on one side of the rear frame (often the right side to stay clear of the primary operator controls, e.g., control levers 127 positioned at the control panel 129 (FIG. 5)). In some embodiments, the primary role of the hydraulic crane 107 is to handle heavy ancillary equipment such as the arbors 113, that often weigh several hundred pounds and are too heavy for manual lifting. In some embodiments, the crane 107 is powered by the engine 131. In some embodiments, during the cable reel 103 installation process, the crane can be used to lift the heavy steel arbor 113 from the reel trailer and move the arbor 113 toward the cable reel 103 and slide it through the center of the cable reel 103. This allows the lift frame assembly 117 to then engage the arbor 113 for the final lift and installation of the cable reel 103 onto the reel trailer 100.

In some embodiments, the telescopic mast pole light 109 (FIG. 1) is mounted on the opposite side of the hydraulic crane 107. The telescopic mast provides high-intensity illumination for the entire work area. Utility work often occurs in emergency outage situations at night. The mast light provides a bird's-eye light source that minimizes shadows around the rear gate 111 and the cable dispensing/retracting area. In some embodiments, the mast is telescopic meaning it can be stowed low for transport to prevent striking overhead bridges or signage. In some embodiments, once the reel trailer is on-site, the telescopic mast pole light 109 is extended vertically via a manual winch or a small pneumatic/hydraulic cylinder. In some embodiments, the telescopic mast pole light 109 features high-output light emitting diode (LED) arrays that can be rotated or tilted by the operator to focus light where the cable is being fed into the underground conduit.

In some embodiments, the placement of telescopic mast pole light 109 and hydraulic crane 107 near the rear gate 111 is a matter of functional efficiency. For example, since the rear gate 111 is the primary entry point for the cable reel 103, having the crane and light at the rear end ensures the critical working zone is both powered and illuminated. Moreover, in certain embodiments, by mounting them on opposite sides, the trailer maintains a better center of gravity and helps prevent uneven tire wear on the tandem axle and ensures stable towing at highway or roadway speeds.

In some embodiments, the reel trailer is provided with winch 115 (FIG. 1). The addition of the winch 115 to the rear gate 111 provides a another layer of control during the cable handling process. While the rim drive arm 135 handles the heavy rotation of the cable reel 103 itself, the winch 115 acts as the precision tender, managing the actual cable 105 lead as it enters or leaves the cable reel 103. In some embodiments, the winch 115 is bolted to a reinforced mounting plate on the rear gate 111. In some embodiments, by being mounted on the gate, the winch 115 remains centered relative to the cable reel 103. In some embodiments, the winch 115 pulls against the rear gate 111, which is mechanically locked to the main frame by the load binder 219, ensuring the winching forces are distributed throughout the entire trailer chassis rather than just the hinges of the rear gate.

In some embodiments, during unwinding, the winch 115 acts as a tensioning brake or a lead puller. For example, if the cable 105 is being pulled into an underground conduit, the winch 115 provides back-tension to prevent the cable reel 103 from over-spinning (free-wheeling), which could cause the cable 105 to bird-nest or tangle. In some embodiments, the winch 115 is configured to pull the heavy head of the cable 105 from the cable reel 103 down to the ground surface 125 or toward the installation point, saving the crew from manual heavy lifting. In some embodiments, because the winch 115 is located at the rear of the reel trailer 100, the operator can use it to guide the cable 105 back and forth across the width of the cable reel 103. This ensures the cable 105 is wound in neat, even layers, which is important for maximizing the capacity of the cable reel 103 and reducing damage to the cable jacket. In some embodiments, the winch 115 is used, together with the rim drive arm 135 and wheels 137, for extraction of old utility cable from the ground onto an empty cable reel 103.

In some embodiments, the reel trailer 100 is implemented with a radio transmitter and remote control system that allowing an operator to move and position the reel trailer for loading of the cable reel 103. In some embodiments, an electronic control layer is implemented over the existing hydraulic and mechanical systems. In some embodiments, the implementation relies on a user interface (transmitter), a logic controller (receiver), and physical actuators (e.g., solenoid valves).

In some embodiments, the transmitter (e.g., the remote) is a rugged, handheld industrial radio remote equipped with dual-axis joysticks (paddles) and toggle switches. The transmitter converts physical movements into encoded radio frequency (RF) signals. In some embodiments, the receiver/controller unit is mounted in an enclosure adjacent engine 131, this unit decodes the RF signals. In some embodiments, the receiver/controller unit is a programmable logic controller (PLC) that interprets the commands and ensures safety interlocks (e.g., preventing the trailer from undesired movement). In some embodiments, manual control levers 127 are replaced or supplemented with electrically actuated solenoid valves. In some embodiments, the solenoid valves open and close in response to electrical pulses from the receiver, directing high-pressure fluid to the various cylinders and motors installed on the reel trailer 100.

In some embodiments, the cable reel 103 loading process requires accurate movements that are enhanced by a remote control. In some embodiments, a dedicated joystick or paddle is configured to control the cylinders. In some embodiments, the operator can stand inches away from the arbor to ensure the arbor slot 117a are sufficiently lined up before initiating the lift. Moreover, in some embodiments, the hydraulic cylinder 141 can be controlled via the remote to operate the extension beams 143 and 145 for expansion. In some embodiments, the motorized vehicle 200 is controllable by way of remote control for maneuvering of the reel trailer in position to receive the cable reel 103. In some embodiments, the implementation of a radio transmitter and remote control system converts the reel trailer into a highly maneuverable, tele-operated machine. By standing outside the danger zone, an operator can precisely navigate the reel trailer and manage the complex loading/unloading sequence with superior visibility.

In some embodiments, the operator uses a ruggedized industrial transmitter, typically featuring dual proportional joysticks (paddles). This allows for step-less control of speed and direction of the motorized vehicle 200 used to move the trailer into position for receiving the cable reel 103. In some embodiments, dual joysticks are provided to emulate the controls of a standard track loader. In some embodiments, dedicated toggle switches are used to actuate secondary functions such as the expansion of the hydraulic cylinder141, the rear gate 111, and the telescopic mast pole light 109. In some embodiments, a safety e-stop is provided on the controller that is configured as a manual kill switch that immediately halts all hydraulic flow by de-energizing the main solenoid valves.

The following is a description of a method flow of operation of the reel trailer in accordance with one embodiment of the present disclosure. In some embodiments, an operation begins with the engine 131 running to provide hydraulic pressure. In some embodiments, the operator stands at the control panel 129, while in other embodiments, the operator uses a radio remote controller to maneuver the crane 107. In some embodiments, because the crane 107 is mounted near the rear gate 111, it has a clear radius that covers both the reel trailer's interior and the area of the ground surface 125 immediately behind the reel trailer 100.

In some embodiments, the crane's telescoping boom is extended, and a lifting sling or specialized arbor hook is attached to the arbor 113. In some embodiments, the crane 107 uses its vertical lift cylinder to hoist the arbor 113 off its transport brackets that are located on the frame of the trailer 100. In some embodiment, using its rotational base, the crane 107 swings the arbor into a perpendicular orientation relative to the reel trailer's longitudinal axis.

In some embodiments, the reel trailer 100 is already in an expanded state and positioned just in front of the cable reel 103. The operator uses the controls for the crane 107 to align the tip of the arbor 113 with the center hole (e.g., “bore”) of the cable reel 103. By either using manual guiding or using the crane's telescoping boom extension, the arbor 113 is slid through the center of the cable reel 103 until it protrudes evenly on both sides. In some embodiments, the crane 107 holds the weight of the arbor 113 until it is centered, ensuring it is ready for the lift assembly 117 to take over.

In some embodiments, the lift assembly 117 is the primary vertical actuator on each side of the reel trailer. In some embodiments, when the reel trailer 100 is backed into position, the lift assembly 117 is adjusted such that both ends of the arbor 113 are rested directly in the arbor slot 117a of the lift assembly 117. In some embodiments, once engaged, the hydraulic cylinders telescope the lift assembly. The synchronization of the left and right cylinders is critical to ensure the cable reel 103 rises level, preventing the arbor 113 from binding or sliding. In some embodiments, at full height, the lift assembly 117 is engaged with spring pins, transferring the load from the hydraulic fluid to the structural steel frame for safe transport.

In some embodiments, the jack outriggers 119 are heavy-duty stabilization legs mounted to the exterior of the main frame (FIG. 2). In some embodiments, the primary purpose of the jack outriggers 119 is to lift the reel trailer's weight off the main axles to facilitate width adjustment of the trailer to accommodate the cable reel 103. When the trailer is sitting on its tires, the friction against the ground surface 125 makes it difficult for the expansion cylinders to move the frame. In some embodiments, by extending the jack outriggers 119, the trailer is jacked up on one side, allowing one frame to slide freely. In some embodiments, the jack outriggers 119 are equipped with heavy-duty caster wheels 119a designed to move along the ground plates 121. These wheels 119a allow the trailer to maintain mobility even while elevated. In some embodiments, this is particularly useful when the operator is using the remote control to fine-tune the trailer's position as the frame expands or contracts.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure. A number of implementations have been described. Nevertheless, it will be understood that various modifications may be made without departing from the spirit and scope of the disclosure. Accordingly, other implementations are within the scope of the following claims.

1. A reel trailer, comprising:
an expandable frame configured to support a cable reel;
a lift assembly mounted on the frame and configured to engage an arbor of the cable reel;
a hydraulic system configured to adjust a width of the frame; and
a rear gate pivotally attached to the frame.

2. The reel trailer of claim 1, further comprising a hydraulic crane mounted on the frame and configured to lift and position the arbor.

3. The reel trailer of claim 1, further comprising a telescopic mast pole light mounted on the frame and configured to provide illumination at a construction site.

4. The reel trailer of claim 1, further comprising a winch mounted on the rear gate and configured to wind or unwind cable from the cable reel.

5. The reel trailer of claim 1, wherein the hydraulic system comprises:
jack outriggers configured to deploy and lift one side of the frame; and
hydraulic cylinders configured to expand and retract the frame.

6. The reel trailer of claim 5, further comprising ground plates configured to provide a stable path for wheels of the jack outriggers during expansion of the frame.

7. The reel trailer of claim 1, further comprising a rim drive arm mounted on the frame and configured to rotate the cable reel, the rim drive arm comprising:
a pair of drive wheels; and
a hydraulic cylinder configured to move the rim drive arm toward and away from the cable reel.

8. A method of operating a reel trailer, comprising:
expanding a width of a frame of the reel trailer using a hydraulic system;
engaging an arbor of a cable reel with a lift assembly mounted on the frame; and
securing the cable reel on the expanded frame.

9. The method of claim 8, further comprising:
deploying jack outriggers to lift one side of the frame; and
expanding the frame using hydraulic cylinders.

10. The method of claim 9, further comprising placing ground plates to provide a stable path for wheels of the jack outriggers during expansion of the frame.

11. The method of claim 8, further comprising using a hydraulic crane mounted on the frame to lift and position the arbor of the cable reel.

12. The method of claim 8, further comprising rotating the cable reel using a rim drive arm mounted on the frame, the rim drive arm comprising a pair of drive wheels.

13. The method of claim 12, further comprising adjusting a position of the rim drive arm relative to the cable reel using a hydraulic cylinder.

14. The method of claim 8, further comprising winding or unwinding cable from the cable reel using a winch mounted on a rear gate of the frame.

15. A cable reel handling system, comprising:
a reel trailer having an expandable frame;
a hydraulic crane mounted on the frame and configured to position an arbor for insertion into a cable reel; and
a rim drive arm mounted on the frame and configured to rotate the cable reel.

16. The cable reel handling system of claim 15, further comprising a lift assembly mounted on the frame and configured to engage the arbor of the cable reel.

17. The cable reel handling system of claim 16, wherein the lift assembly comprises:
an arbor slot configured to receive the arbor; and
a support ledge positioned below the arbor slot to provide support for the arbor when loaded.

18. The cable reel handling system of claim 17, wherein the lift assembly further comprises a panel door configured to secure the arbor within the lift assembly when closed.

19. The cable reel handling system of claim 15, wherein the rim drive arm comprises:
a pair of drive wheels configured to contact an outer surface of the cable reel; and
a hydraulic cylinder configured to move the rim drive arm toward and away from the cable reel.

20. The cable reel handling system of claim 16, further comprising a control panel with levers configured to operate the hydraulic crane, the rim drive arm, and the lift assembly.
